(19) United States
(12) Patent Application Publication
(10) Pub. No.: US 2014/0256436 A1
(43) Pub. Date: Sep. 11, 2014

(54) METHOD AND APPARATUS FOR MANAGING PERIPHERAL DEVICE INPUTS

(71) Applicant: Steelseries ApS, Valby (DK)

(72) Inventors: Francis Arnold Grever, Palatine, IL (US); Kim Rom, Chicago, IL (US); Jeffrey Nicholas Mahlmeister, Chicago, IL (US); Jacob Wolff-Petersen, Richmond (GB); Bruce Hawver, Hawthorn Woods, IL (US); Tino Soelberg, Copenhagen (DK); Christopher John Nicolella, Elk Grove Village, IL (US)

(73) Assignee: STEELSERIES APS, Valby (DK)

(21) Appl. No.: 13/788,652

(22) Filed: Mar. 7, 2013

(51) Int. Cl. A63F 13/20

(52) U.S. Cl. CPC A63F 13/06
USPC 463/36

(57) ABSTRACT

A system that incorporates teachings of the present disclosure may include, for example, a system that determine whether a user input stimulus is an invalid stimulus for a video game where the user input stimulus is generated based on a movement of a peripheral device, and causes an adjustment or deletion of the user input stimulus responsive to a determination that the user input stimulus is the invalid stimulus for the video game. Additional embodiments are disclosed.

### FIELD OF THE DISCLOSURE

The present disclosure relates generally to a method and apparatus for managing peripheral device inputs.

### BACKGROUND

It is common today for gamers or users of computing devices to utilize motion sensitive accessories that generate user input stimuli based on a detected motion. The accuracy of the stimuli can depend on a number of factors including the sensitivity of the motion sensor. Some software applications, including video games, can provide for a large range of potential actions based on user input stimuli. The accuracy of the generated stimuli compared to the intended stimuli can have an effect on control over the software application.

### BRIEF DESCRIPTION OF THE DRAWINGS

Reference will now be made to the accompanying drawings, which are not necessarily drawn to scale, and wherein:

FIG. 1 depicts an illustrative embodiment of a system for managing peripheral device inputs according to the present disclosure;

FIGS. 2A-C depict illustrative embodiments of a peripheral device providing user inputs utilizing the system of FIG. 1;

FIG. 3 depicts a method describing management of peripheral device inputs according to the present disclosure;

FIG. 4 depicts an illustrative embodiment of a system for managing peripheral device inputs according to the present disclosure;

FIG. 5 depicts an illustrative embodiment of a Graphical User Interface (GUI) generated by an Accessory Management Software (AMS) application according to the present disclosure;

FIGS. 6-7 depict illustrative embodiments for communicatively coupling a gaming controller to a computing device;

FIG. 8 depicts an illustrative embodiment of a communication device;

FIGS. 9-11 depict methods describing illustrative embodiments of the AMS application; and

FIG. 12 depicts an illustrative diagrammatic representation of a machine in the form of a computer system within which a set of instructions, when executed, may cause the machine to perform any one or more of the methodologies disclosed herein.

### DETAILED DESCRIPTION

The subject disclosure describes, among other things, illustrative embodiments for filtering, smoothing or otherwise adjusting user inputs generated by a peripheral device. The input adjustment can be based on determining erroneous or improper user inputs and deleting or otherwise adjusting those erroneous or improper inputs. The detection and processing of the erratic movements of the peripheral device can be performed by a module removably connectable with the peripheral device and/or by an apparatus integrated with the peripheral device.

One or more of the embodiments can detect erroneous acceleration movements, erroneous orientation movements and/or erroneous directional movements associated with a peripheral device and can adjust the user input(s) generated via the peripheral device to compensate for the detected erroneous movement(s). In one or more of the embodiments, the detection of the erroneous movements can be based on a type of software application receiving the user inputs (e.g., a type of video game such as a car driving game that senses movement of the peripheral device steering wheel). In one or more of the embodiments, the detection of the erroneous movements can be based on a type of peripheral device generating the user inputs, such as a wireless peripheral device that is a steering wheel or a tennis racket whose movement can be detected by a gaming console.

In one or more embodiments, movement sensor(s) in the peripheral device can detect movement and can determine if the detected movement is associated with a desired user input or if the detected movement is associated with an erroneous or improper user input. Based on the movement detection and determination, user inputs generated from the peripheral device can be filtered, smoothed or otherwise adjusted.

As an example, a car wheel peripheral device can be shaken which can lead the peripheral device to generate a stimulus that indicates the car wheel was turned. The car wheel peripheral device can be adapted with an accelerometer, gyroscope, and/or magnetometer to detect improper acceleration movements, improper orientation movements, and/or improper directional movements. In this example, a software kernel can operate from the peripheral device to smooth out stimuli and/or filter stimuli altogether when these improper movements are detected. In this example, the software kernel can inform user interface (UI) software or UI engine when these events occur so that the UI can coach or otherwise notify the user to avoid the erratic movements. The adaptation of the peripheral device with the component(s) and algorithm(s) that enable self-correction of the peripheral device can be done using separate components and/or components integrated with the peripheral device.

Other embodiments are contemplated by the subject disclosure.

One embodiment of the present disclosure can be a method that includes determining a movement associated with a peripheral device. The method can include determining, by a processor of a system, whether a user input stimulus is an invalid stimulus for a video game based on the determining of the movement. The method can include causing, by the processor, a stimuli signal to be adjusted to generate an adjusted stimuli signal responsive to a determination that the user input stimulus is the invalid stimulus for the video game, wherein the stimuli signal is generated by the peripheral device and includes the user input stimulus.

One embodiment of the present disclosure can entail a method that includes detecting, by a movement sensor of a system, a movement of a peripheral device, wherein the movement generates a user input stimulus for a video game. The method can include determining, by a processor of the system, whether the user input stimulus is an invalid stimulus for the video game. The method can include causing, by the processor, a stimuli signal to be adjusted to generate an adjusted stimuli signal responsive to a determination that the user input stimulus is the invalid stimulus for the video game, wherein the stimuli signal is generated by the peripheral device and includes the user input stimulus.

One embodiment of the present disclosure can entail an apparatus that includes a memory to store computer instructions, a movement sensor, and a processor coupled with the memory and the movement sensor. The processor, responsive to executing the computer instructions, can perform operations including detecting a movement of a peripheral device utilizing the movement sensor, where the user input stimulus is generated for a video game according to the movement. The apparatus can cause a stimuli signal to be adjusted to generate an adjusted stimuli signal responsive to a determination that the user input stimulus is an invalid stimulus for a video game, where the stimuli signal includes the user input stimulus, and where the adjusted stimuli signal is provided to a computing device presenting the video game.

One embodiment of the present disclosure can entail a non-transitory computer-readable storage medium comprising computer instructions which, responsive to being executed by a processor, cause the processor to perform operations including determining whether a user input stimulus is an invalid stimulus for a video game where the user input stimulus is generated based on a movement of a peripheral device, and causing an adjustment or deletion of the user input stimulus responsive to a determination that the user input stimulus is the invalid stimulus for the video game.

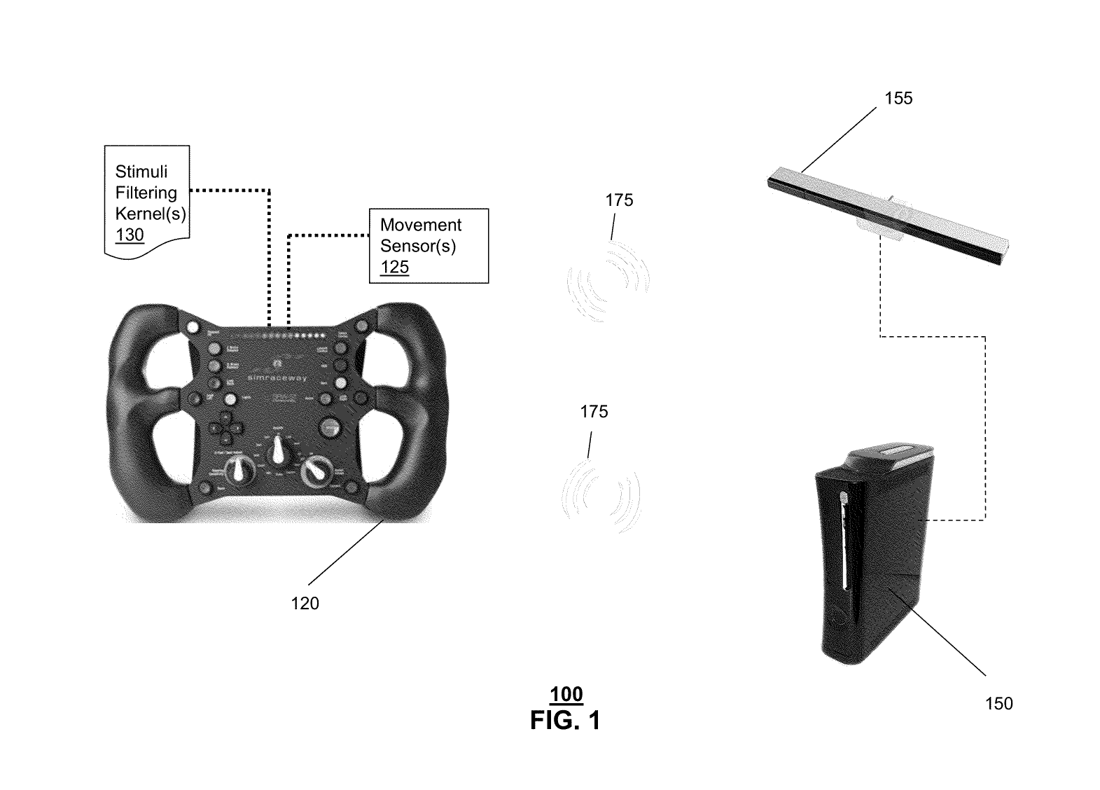

FIG. 1 depicts an illustrative embodiment of a system 100 that can provide a self-correcting peripheral device 120. The peripheral device 120 can be in communication with a computing device 150 (e.g., a gaming console). The peripheral device 120 can be a user interface to the computing device 150, such as by transmitting or otherwise providing user input stimuli 175 to the computing device 150 and/or to other components in communication with the computing device, such as a sensor bar 155. The user input stimuli 175 can be transmitted via hardwire and/or wireless communication links between the peripheral device 120 and the computing device 150 (and/or other component 155). The stimuli 175 can be any amount of stimuli information and any type of stimuli information, including movement data, speed data, position data, and so forth. Peripheral device 120 is illustrated as a steering wheel, but other peripheral devices can also be utilized including remote controllers, wands, tennis rackets, baseball bats, toy firearms and so forth.

In one or more embodiments, peripheral device 120 can include one or more movement sensors 125 for detection of movement of the peripheral device. The movement sensors 125 can be of various types including an accelerometer, a gyroscope, and/or a magnetometer. In one embodiment, the movement sensors 125 can be integrated with the peripheral device 125, such as used to generate user input stimuli based on a detected motion of the peripheral device. In another embodiment, the movement sensors 125 can be module(s) that are connectable with the peripheral device 120, such as a separate movement sensor 125 that can be coupled to the peripheral device and utilized for detecting the peripheral device movement separately from an internal motion detector of the peripheral device. In one or more embodiments, the peripheral device 120 can include a software kernel 130 or other software code for processing data associated with the movement sensors 125.

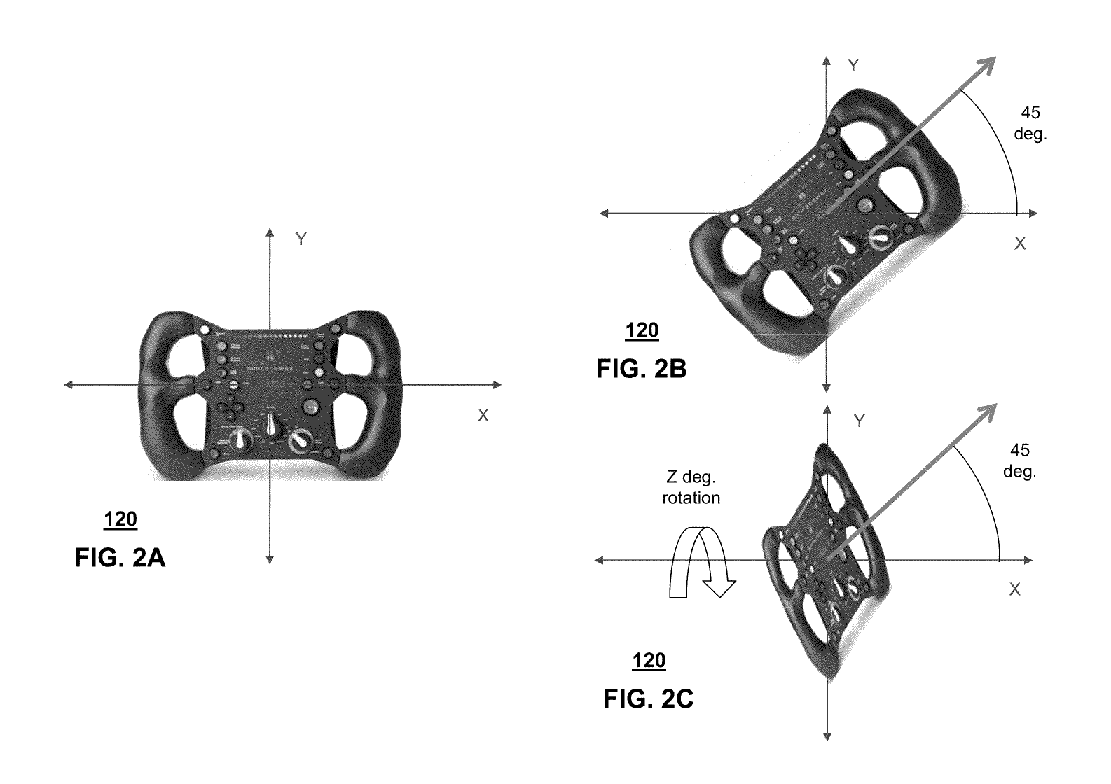

Referring additionally to FIGS. 2A-2C, movement of the peripheral device 120 can be in various directions which, in certain instances, can result in undesired or unintended user input stimuli being generated. FIG. 2A depicts the steering wheel peripheral device 120 in a first non-biased state in which it has not been moved and would not provide any user input stimuli for turning in a video game. FIG. 2B depicts the steering peripheral device 120 in a second biased state in which it has been moved (e.g., 45 degree rotation in the X-Y plane) and would provide a user input stimuli for turning to the left in the video game. The amount of turning in the video game would depend on the corresponding ratio of peripheral device movement to video game movement, which, if a one-to-one ratio were used in this example, would result in a 45 degree turn in the video game. The exemplary embodiments contemplate the ratios being user adjustable (e.g., user preferences in a user profile) and/or automatically adjusted (e.g., adjusted without user initiation based on data feedback that identifies a history of over-steering by the user). FIG. 2C depicts the steering peripheral device 120 in a third biased state in which it has been moved (e.g., 45 degree rotation in the X-Y plane as well as a Z degree of rotation). In this third biased state, the generated user input stimuli may include erroneous information for turning due to the Z rotation. For instance, the Z degree rotation may result in a left turn rotation that is more than the desired 45 degree rotation. This example illustrates movement outside of the X-Y plane (e.g., Z degree rotation) that can provide an erroneous user input stimuli, however, other peripheral device movement can also result in erroneous or improper user input stimuli being generated. For example, the steering wheel peripheral device 120 may be shaken which can result in generating an improper user input stimuli representing a turning motion.

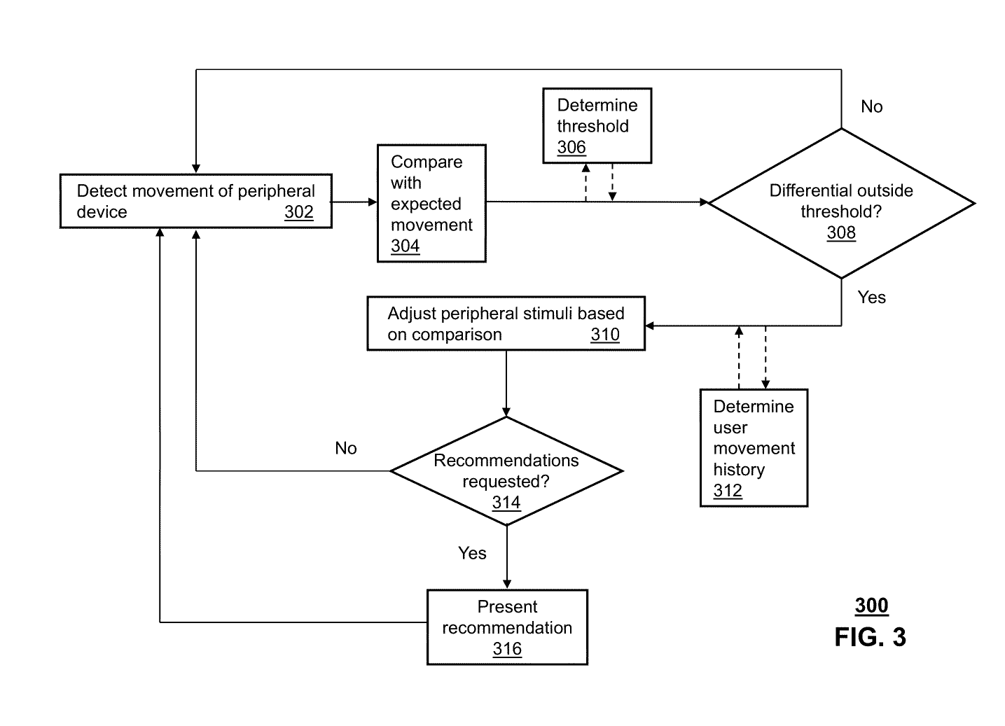

Referring to FIG. 3, a method 300 is illustrated for enabling peripheral device 120 to perform self-correction. Method 300 can commence at 302 where movement of the peripheral device 120 is detected. The peripheral device movement can be detected by various types of sensors (e.g., an accelerometer, a gyroscope, and/or a magnetometer) and any number of these sensors. In one or more embodiments, the movement of peripheral device 120 can generate a user input stimuli for control over a software application being executed by the computing device 150. The software application can be various types, including video gaming software, but can also be other types such as Computer Aided Drawing software and so forth. As examples of the generated user input stimuli, a steering wheel peripheral device 120 can be rotated to the left to generate a left turn in an auto racing video game; a tennis racket can be swung in a forehand motion to generate a forehand swing in a tennis video game; a baseball bat can be swung to generate a bat swing in a baseball video game; and so forth. The particular type of peripheral device 120 and the type of software application (e.g., type of game) can vary in method 300. It should be understood that the detection of the movement of the peripheral device 120 can be a separate step from the generation of the user input stimuli based on the movement (e.g., performed by movement sensor(s) that are different from movement sensor(s) that are utilized for generating the stimuli); or can be an integrated step with the generation of the stimuli, such as a single movement sensor determining acceleration, direction, and/or orientation data which is utilized to generate the stimuli and which is also utilized by method 300 for self-correction of the peripheral device.

At 304, the detected movement of the peripheral device 120 can be compared with expected movement of the peripheral device. For instance, a steering wheel peripheral device 120 can be expected to move in an X-Y plane (see FIG. 2B) for left and right steering in an auto-racing video game. The steering wheel device 120 in this example may also be expected to move over a particular range, such as a total rotation of no more than 90 degrees. The expected movement can also be based on knowing movement which is improper, such as in the above example rotational movement in a Z plane. In one or more embodiments, the expected movement can be no movement. The expected movement can be determined based on various criteria and using various techniques, such as a type of video game and/or a type of peripheral device.

In one or more embodiments, the expected movement can be determined based on a monitored history of user input stimuli that was determined to be successful in the video game. The monitoring can be performed by various components or combinations of components. For instance, the peripheral device, the computing device and/or a backend server can store user input stimuli received from a user and index the stimuli against events occurring in the video game to identify or otherwise determine successful stimuli in the video game. The successful stimuli can be analyzed, such as over multiple times the video game was played by the user and/or multiple users playing the video game, to determine the range of successful movements of the peripheral device for that event (or point in the game such as a position on a racetrack). These successful peripheral device movements can be used to establish expected peripheral device movement, which may be a range of movements that are expected.

In one or more embodiments at 306, a movement threshold can be determined or otherwise identified for the comparison of the detected movement with the expected movement of the peripheral device 120. For instance in the above example, it can be determined that rotation in the Z plane of a particular amount is a tolerable rotation for the peripheral device 120 which does not require adjustment (as will be explained later). The threshold can be based on tolerances of the movement sensor(s) 125 being utilized for detecting the movement of the peripheral device 120. For instance, if a movement sensor 125 of a tennis racket peripheral device 120 only detects movement greater than 5 mm then the threshold of step 306 can be set at 5 mm. The movement threshold can be determined based on various criteria and using various techniques, such as a type of video game and/or a type of peripheral device. In one or more embodiments, the movement threshold can be determined based on a monitored history of user input stimuli that was determined to be successful in the video game.

At 308, a determination can be made as to whether the detected movement of the peripheral device 120 as compared to the expected movement is outside of the movement threshold. If the detected movement is within the threshold then method 300 can return to 302 to continue monitoring for movement of the peripheral device 120. If on the other hand, the detected movement is outside of the threshold then at 310 an adjustment to the peripheral stimuli can be performed. The adjustment can include modifying the movement data (e.g., smoothing of the data) and/or deleting the user input stimuli. As an example, shaking of a steering wheel peripheral device 120 can be detected (e.g., detecting back and forth movements in the Z plane) where movement in the X-Y plane of less than 20 degrees was expected (e.g., the auto-racing video game was at a relatively straight portion of the track). The shaking movement in this example can be outside of the movement threshold resulting in the adjustment of the peripheral stimuli to reduce or eliminate the erratic movement (in this example the shaking movement).

In one embodiment, the peripheral stimuli provided from the peripheral device 120 to the computing device 150 can be modified so that the data represents movement of the peripheral device without the erratic movement that falls outside of the movement threshold. For instance, if the expected movement is turning up to 20 degrees and the detected movement (which includes a rotation in the X-Y plane and the shaking movement) generates a user input stimuli for turning 25 degrees then the peripheral stimuli can be adjusted so that the video game receives a control signal turning 20 degrees.

In one embodiment, the user input stimuli generated by erratic movement can be deleted in whole. For instance, if the only detected movement is erratic movement without any discernible proper movement of the steering wheel peripheral device 120 then the user input stimuli can be deleted in whole. As an example, the detected movement can be only shaking movement in the Z direction without any rotation in the X-Y plane. If a user input stimuli is generated that would result in a 5 degree turn of the steering wheel in the video game then that user input stimuli can be deleted or otherwise prevented from being provided to the computing device 150 since it is based only on erratic movement.

In one or more embodiments at 312, the adjustment to the user input stimuli can be based on a monitored history of user input stimuli for the user (and/or from other users). The monitored history can be based on user input stimuli limited to the particular video game or limited to a genre of the video game (e.g., auto-racing video games). For example, the monitored history can be analyzed to determine user tendencies so that the tendencies are taken into consideration when adjusting the stimuli. As an example, a monitored user history can identify that a user has a tendency of moving into the inside of a track using a gradual 7 degree turn prior to reaching a curve. The adjustment at step 310 can take this user tendency into account so that a generated user stimuli based on a detected movement that includes both intended and erratic movement (e.g., a rotation of 4 degrees in the X-Y plane with an additional rotation in the Z plane) can be adjusted to the 7 degree turn. In this example, the user input stimuli is increased from 4 degrees to 7 degrees to account for the user making erratic movement that was intended to provide more of a turn. In this example, the stimuli adjustment increases the movement in the video game, but the exemplary embodiments can also decrease the movement in the video game. The monitoring can be performed by various components or combinations of components.

As another example, a monitored user history can identify that a user has a tendency of swinging a tennis racket (peripheral device 120) ninety degrees in the X-Z plane with no movement in the Y direction. The adjustment at step 310 can take the determined user tendency into account so that a generated user stimuli based on a detected movement of the tennis racket peripheral device that includes both intended and erratic movement (e.g., a forehand swing of 90 degrees in the X-Z plane followed by an additional movement in the Y direction) can be adjusted to only the forehand 90 degree swing. In this example, the user input stimuli is adjusted to remove the unintentional Y direction movement of the tennis racket peripheral device to account for the user making erratic movement at the end of the swinging motion.

In one or more embodiments, the adjustment of the user input stimuli can be based on monitored history and successful stimuli. For example, the peripheral device, the computing device and/or a backend server can store user input stimuli received from a user and index the stimuli against events occurring in the video game to identify or otherwise determine successful stimuli in the video game. The successful stimuli can be analyzed, such as over multiple times the video game was played by the user and/or multiple users playing the video game, to determine the range of successful movements of the peripheral device for that event (or point in the game such as a position on a racetrack). These successful peripheral device movements can be used to adjust the user input stimuli that includes erratic movement. In one embodiment, a first filtering mechanism can be applied for adjusting the user input stimuli based on a range of successful stimuli and a second filtering mechanism can be applied for adjusting the user input stimuli based on a range of user input stimuli previously utilized by the user (e.g., based on the monitored history of the user that provides user tendencies).

In one embodiment, the amount or degree of adjustment of the user input stimuli can be based on the amount or degree that the detected movement is outside of the movement threshold. In one embodiment, multiple movement thresholds can be utilized and can determine whether the user input stimuli is adjusted or deleted. For example, if a detected movement falls outside of a first smaller movement threshold but within a second larger movement threshold then the user input stimuli may be adjusted, while if the detected movement falls outside of both thresholds the user input stimuli may be deleted in whole. This technique can also be reversed so that adjustment of the user input stimuli occurs when the detected movement is outside of both thresholds but the user input stimuli is deleted if the detected movement is only outside of the smaller threshold.

In one embodiment at 314 and 316, information can be presented to the user, for example if requested, regarding detected movements and any adjustments made to user input stimuli. For instance, a user can request recommendations be presented (visually and/or audibly) that indicate adjustment made based on unintended or erratic movements. Other recommendations can be presented, with or without user preferences being considered, where the recommendations provide various information associated with the detected movement and/or the expected movement, such as coaching instructions to advise the player as to how to avoid the erratic movement or how to avoid stimuli that would result in unsuccessful game inputs.

Method 300 can operate as a continuous or sporadic process so that peripheral device 120 can operate as a self-correcting device. In one or more embodiments, the degree of self-correction can be adjustable. For example, the peripheral device 120 can provide for self-correction to eliminate or otherwise adjust stimuli generated from erratic movement that would provide for catastrophic game results (e.g., a car crashing into a wall in an auto-racing video game) while allowing less optimal stimuli (e.g., a switching of lanes that slows the vehicle down but does not result in a car crash) to be transmitted to the computing device. In one or more embodiments, the degree of self-correction can be controlled by the user who can designate the level of expected movements to be utilized at step 304, such as designating expected movements based on known successful movements or designating expected movements based on the user's tendencies.

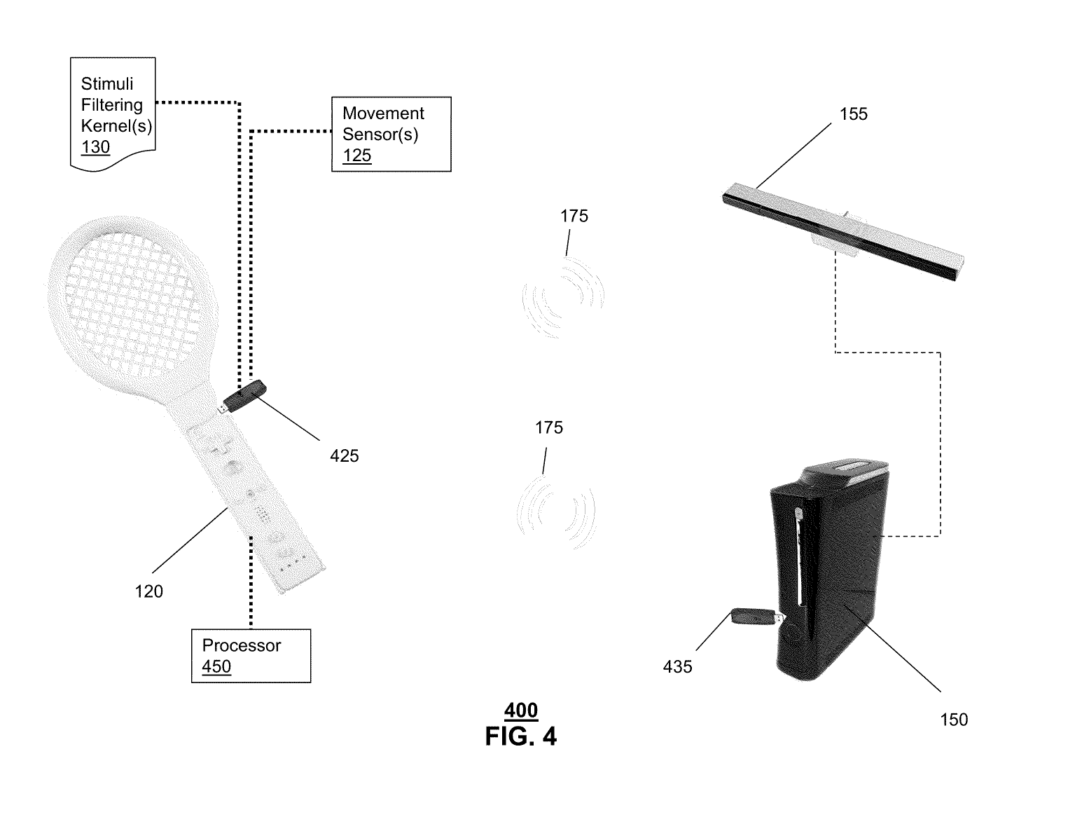

FIG. 4 depicts an illustrative embodiment of a system 400 that can provide self-correction for the peripheral device 120 through use of a peripheral filtering module 425. Similar to system 100 of FIG. 1, the peripheral device 120 can be in communication with the computing device 150 (e.g., a gaming console). The peripheral device 120 can be a user interface to the computing device 150, such as by transmitting or otherwise providing user input stimul±175 to the computing device 150 and/or to other components in communication with the computing device, such as the sensor bar 155. The user input stimuli 175 can be transmitted via hardwire and/or wireless communication links between the peripheral device 120 and the computing device 150 (and/or other component 155). Peripheral device 120 is illustrated as a tennis racket, but other peripheral devices can also be utilized including remote controllers, wands, steering wheels, baseball bats, toy firearms and so forth.

In one or more embodiments, peripheral filtering module 425 can include one or more of the movement sensors 125 for detection of movement of the peripheral device. The movement sensors 125 can be of various types including an accelerometer, a gyroscope, and/or a magnetometer. In one or more embodiments, the peripheral filtering module 425 can include the software kernel 130 for processing data associated with the movement sensors 125.

In this embodiment, the peripheral filtering module 425 can be a self-contained module that is connectable with the peripheral device 120. In one or more embodiments, the peripheral filtering module 425 can be in communication with a processor 450 of the peripheral device 120 for enabling self-correction such as described in method 300. For instance, the peripheral filtering module 425 can communicate with the processor 450 to adjust generated user input stimuli based on detected movements that are detected by the movement sensor(s) 125 of the module. For example, the processor 450 can detect a swing of the tennis racket peripheral device 120 utilizing an integrated movement sensor (not shown) of the tennis racket peripheral device and can generate a user input stimuli. The peripheral filtering module 425 can also detect the swing using its movement sensor(s) 125 and can apply method 300 to determine whether an adjustment to the generated user input stimuli is warranted. If an adjustment is warranted then the peripheral filtering module 425 can either generate the adjusted user input stimuli (such as by retrieving the generated user input stimuli from the processor 450) and/or can provide instructions or data (e.g., from a comparison to expected movement as in method 300) that enable the processor 450 to generate the adjusted user input stimuli. In one or more embodiments, the peripheral filtering module 425 can plug into a hardwire interface of the peripheral device 120 to act as a gatekeeper for outgoing user input stimuli transmissions. In this example, the processor 450 can generate the user input stimuli but the stimuli can then be adjusted by the peripheral device filtering module 425 once it is received at the hardwire interface.

In one or more embodiments, the peripheral filtering module 425 can be in communication with the computing device 150 for enabling self-correction such as described in method 300. For instance, the peripheral filtering module 425 can communicate with the computing device 150 to adjust generated user input stimuli based on detected movements that are detected by the movement sensor(s) 125 of the module. For example, the processor 450 of the tennis racket peripheral device 120 can detect a swing utilizing an integrated movement sensor (not shown) of the tennis racket peripheral device and can generate a user input stimuli. The user input stimuli 175 can be wirelessly transmitted to the computing device 150. The peripheral filtering module 425 can also detect the swing using its movement sensor(s) 125 and can apply method 300 to determine whether an adjustment to the generated user input stimuli is warranted. If an adjustment is warranted then the peripheral filtering module 425 can generate and transmit the adjusted user input stimuli to the computing device 150 (such as by retrieving the generated user input stimuli from the processor 450 and adjusting according to method 300) and/or can transmit instructions or data (e.g., from a comparison to expected movement as in method 300) that enable the computing device 150 to generate the adjusted user input stimuli. In one or more embodiments, the peripheral filtering module 425 can be paired with or otherwise communicate with a receiver filtering module 435 that plugs into the computing device 120 (e.g., via a USB port or hardwire interface) to facilitate communication of the adjusted user input stimuli and/or communication of the instructions/data for generating the adjusted user input stimuli to the computing device 120. In this example, the peripheral filtering module 425 and the receiver filtering module 435 can communicate wirelessly via various means and protocols, including IR signals or Bluetooth®.

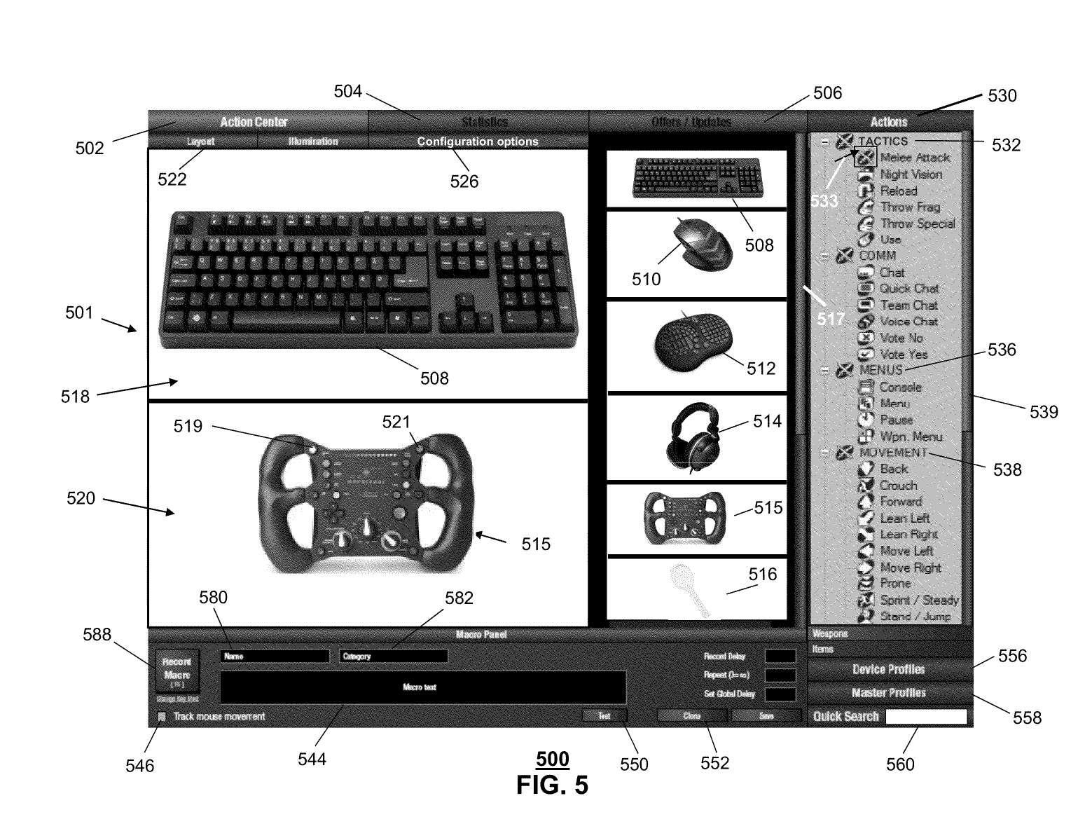

FIG. 5 depicts an illustrative embodiment of a Graphical User Interface (GUI) generated by an Accessory Management Software (AMS) application according to the present disclosure. The AMS application can be executed by a computing device such as a desktop computer, a laptop computer, a server, a mainframe computer, a gaming console, a gaming accessory, or combinations or portions thereof. The AMS application can also be executed by portable computing devices (with computing resources) such as a cellular phone, a personal digital assistant, or a media player (such as an iPOD™). It is contemplated that the AMS application can be executed by any device with suitable computing resources. The AMS application enables a user to provide information associated with filtering out erratic movements with respect to particular peripheral devices. For example, the user can input preferences, such as enabling presentation of recommendation as to how to avoid erratic movements. Other user preferences can also be provided via the AMS application, such as the degree and/or technique for self-correction to be applied to a peripheral device. For instance, the user can select whether self-correction is to be applied based on a monitored user history of tendencies and/or successful stimuli. The user can also select whether data from other users can be utilized in the self-correction algorithm, such as a monitored input stimuli history of another user or monitored history of other video games in the same genre (such as other auto-racing video games).

In one or more embodiments, the AMS application can allow the user to select movement thresholds that are used in distinguishing between erratic (unintended) movement and intended movement. For instance, the user can select a percentage threshold that is applied so that movements that fall a certain percentage outside of the expected movement will be deemed erratic movement (e.g., steering wheel movement in the Y direction of more than 6 inches which would likely indicate dropping of the steering wheel peripheral device). In one or more embodiments, the AMS application can enable the user to generate baseline movements that are to be utilized for the expected movement. For instance, the user can move a tennis racket peripheral device is a forehand motion which is recorded by the AMS application (e.g., by depressing the track movement button 546 shown in FIG. 5) and later utilized for the expected movement. In this example, the method 300 can apply a movement threshold to the expected (recorded) forehand movement to determine whether the detected movement falls outside of the threshold of the expected forehand movement.

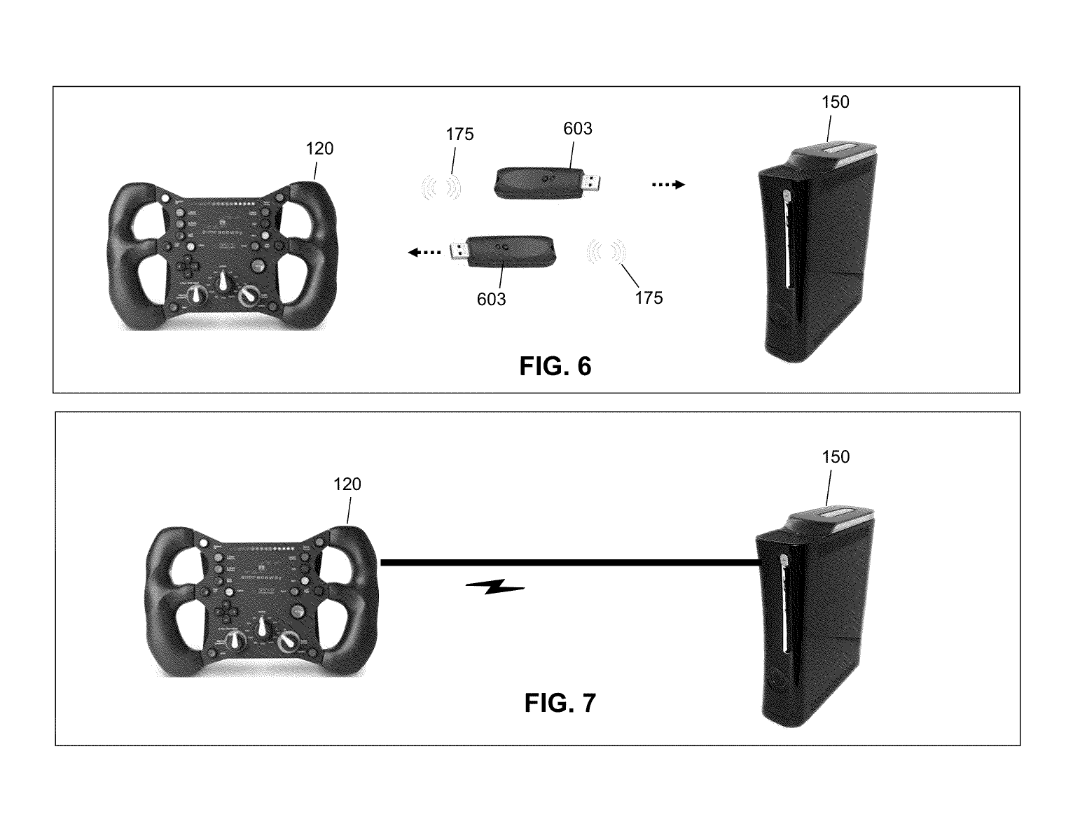

FIG. 6 illustrates a number of embodiments for utilizing a wireless dongle 603 with a gaming accessory (such as steering wheel accessory 120) and/or the computing device 150 (herein referred to as gaming console 150). In the illustration of FIG. 6, the USB portion of the dongle 603 can be physically engaged with the steering wheel accessory 120 or the gaming console 150. The dongle 603 in either of these configurations can facilitate wireless communications 175 between the steering wheel accessory 120 and the gaming console 150 (e.g., WiFi, Bluetooth, ZigBee, or proprietary protocol). It is contemplated that functions of the dongle 603 can in whole or in part be an integral part of the steering wheel accessory 120 or the gaming console 150. It is also contemplated that the AMS application can in whole or in part be executed by computing resources of the dongle 603.

In one embodiment, the steering wheel accessory can be tethered to a computer computing device such as the gaming console 150 by a cable (e.g., USB cable) as shown in FIG. 7 to provide a means of communication less susceptible to electromagnetic interference or other sources of wireless interference. In one embodiment, the steering wheel accessory 120 and the gaming console 150 can have an integrated wireless interface for wireless communications therebetween. It is contemplated that the AMS application can in whole or in part be executed by computing resources of the steering wheel accessory 120, the gaming console 150, or combinations thereof.

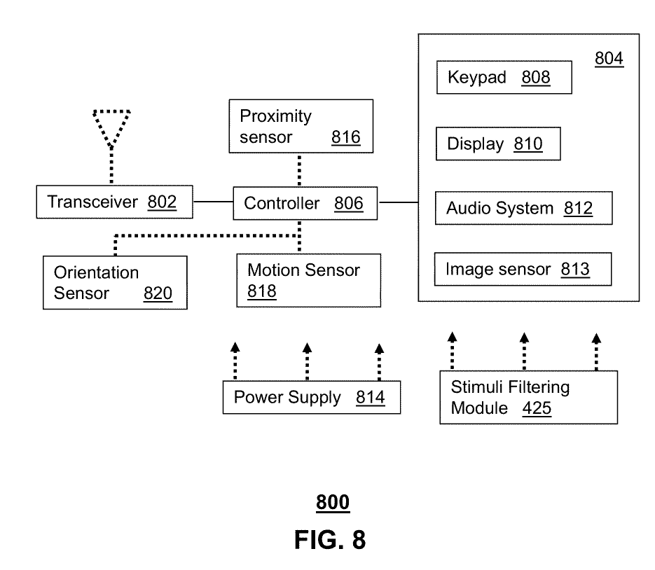

FIG. 8 depicts an illustrative embodiment of a communication device 800. Communication device 800 can serve in whole or in part as an illustrative embodiment of the devices depicted or otherwise utilized in FIGS. 1-7. The communication device 800 can be a peripheral device (e.g., peripheral device 120) capable of self-correction of user input stimuli. The self-correction be implemented via internal components and techniques and/or can be implement via external components and techniques (e.g., via stimuli filtering module 425 removable connectable with the device 800.

The communication device 800 can comprise a wireline and/or wireless transceiver 802 (herein transceiver 802), a user interface (UI) 804, a power supply 814, a proximity sensor 816, a motion sensor 818, an orientation sensor 820, and a controller 806 for managing operations thereof. The transceiver 802 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, software defined radio (SDR), Long Term Evolution (LTE), as well as other next generation wireless communication technologies as they arise. The transceiver 802 can also be adapted to support circuit-switched wireline access technologies (such as PSTN), packet-switched wireline access technologies (such as TCP/IP, VoIP, etc.), and combinations thereof.

The UI 804 can include a depressible or touch-sensitive keypad 808 coupled to a navigation mechanism such as a roller ball, a joystick, a mouse, or a navigation disk for manipulating operations of the communication device 800. The keypad 808 can be an integral part of a housing assembly of the communication device 800 or an independent device operably coupled thereto by a tethered wireline interface (such as a USB cable) or a wireless interface supporting for example Bluetooth. The keypad 808 can represent a numeric keypad, and/or a QWERTY keypad with alphanumeric keys. The UI 804 can further include a display 810 such as monochrome or color LCD (Liquid Crystal Display), OLED (Organic Light Emitting Diode) or other suitable display technology for conveying images to an end user of the communication device 800.

In an embodiment where the display 810 is touch-sensitive, a portion or all of the keypad 808 can be presented by way of the display 810 with navigation features (e.g., an iPad™, iPhone™, or Android™ phone or tablet). As a touch screen display, the communication device 800 can be adapted to present a user interface with graphical user interface (GUI) elements that can be selected by a user with a touch of a finger. The touch screen display 810 can be equipped with capacitive, resistive or other forms of sensing technology to detect how much surface area of a user's finger has been placed on a portion of the touch screen display. This sensing information can be used to control the manipulation of the GUI elements.

The UI 804 can also include an audio system 812 that utilizes common audio technology for conveying low volume audio (such as audio heard only in the proximity of a human ear) and high volume audio (such as speakerphone for hands free operation, stereo or surround sound system). The audio system 812 can further include a microphone for receiving audible signals of an end user. The audio system 812 can also be used for voice recognition applications. The UI 808 can further include an image sensor 813 such as a charged coupled device (CCD) camera for capturing still or moving images and performing image recognition therefrom.

The power supply 818 can utilize common power management technologies such as replaceable or rechargeable batteries, supply regulation technologies, and charging system technologies for supplying energy to the components of the communication device 800 to facilitate long-range or short-range portable applications. Alternatively, the charging system can utilize external power sources such as DC power supplied over a physical interface such as a USB port or by way of a power cord attached to a transformer that converts AC to DC power.

The proximity sensor 816 can utilize proximity sensing technology such as an electromagnetic sensor, a capacitive sensor, an inductive sensor, an image sensor or combinations thereof. The motion sensor 818 can utilize motion sensing technology such as an accelerometer, a gyroscope, or other suitable motion sensing technology to detect movement of the communication device 800 in three-dimensional space. The orientation sensor 820 can utilize orientation sensing technology such as a magnetometer to detect the orientation of the communication device 800 (North, South, West, East, combined orientations thereof in degrees, minutes, or other suitable orientation metrics).

The communication device 800 can use the transceiver 802 to also determine a proximity to a cellular, WiFi, Bluetooth, or other wireless access points by common sensing techniques such as utilizing a received signal strength indicator (RSSI) and/or a signal time of arrival (TOA) or time of flight (TOF). The controller 806 can utilize computing technologies such as a microprocessor, a digital signal processor (DSP), and/or a video processor with associated storage memory such as Flash, ROM, RAM, SRAM, DRAM or other storage technologies.

Other components not shown in FIG. 8 are contemplated by the present disclosure. For instance, the communication device 800 can include a reset button (not shown). The reset button can be used to reset the controller 806 of the communication device 800. In yet another embodiment, the communication device 800 can also include a factory default setting button positioned below a small hole in a housing assembly of the communication device 800 to force the communication device 800 to re-establish factory settings. In this embodiment, a user can use a protruding object such as a pen or paper clip tip to reach into the hole and depress the default setting button.

The communication device 800 as described herein can operate with more or less components described in FIG. 8 to accommodate the implementation of the devices described by the present disclosure. These variant embodiments are contemplated by the present disclosure.

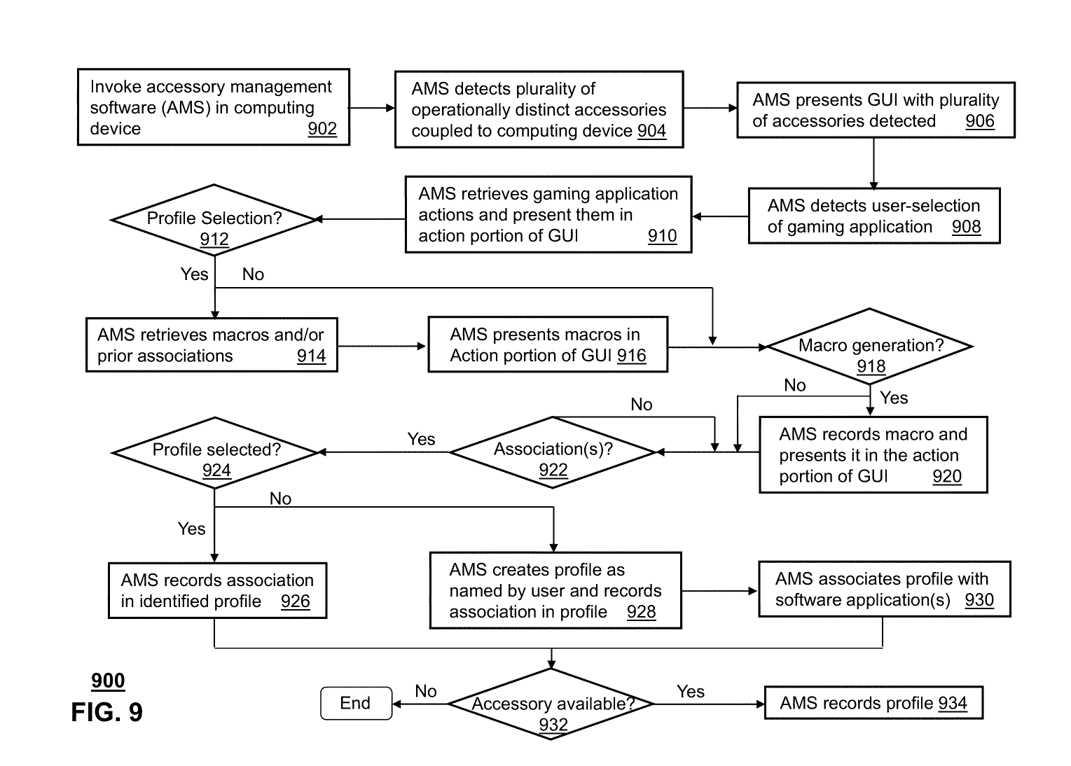

FIGS. 9-11 depict methods 900-1100 describing illustrative embodiments of the AMS application. Method 900 can begin with step 902 in which the AMS application is invoked in a computing device. The computing device can be a remote server (not shown), the gaming console 150, or any other computing device with suitable computing resources. The invocation step can result from a user selection of the AMS application from a menu or iconic symbol presented on a desktop of the computing device by an operating system (OS) managing operations thereof. In step 904, the AMS application can detect by way of drivers in the OS a plurality of operationally distinct accessories communicatively coupled to the computing device. The accessories can be coupled to the computing device by a tethered interface (e.g., USB cable), a wireless interface (e.g., Bluetooth or Wireless Fidelity—WiFi), or combinations thereof.

In the present context, an accessory can represent any type of device which can be communicatively coupled to the computing device (or an integral part of the computing device) and which can control aspects of the OS and/or a software application operating in the computing device. An accessory can represent for example a keyboard, a touch screen display, a gaming pad, a gaming controller, a mouse, a joystick, a microphone, or a headset with a microphone—just to mention a few.

In step 906, the AMS application presents a GUI 501 such as depicted in FIG. 5 with operationally distinct accessories such as a keyboard 508, and a gaming controller 515 (e.g., steering wheel or tennis racket device 120). The GUI 501 presents the accessories 508-516 in a scrollable section 517. One or more accessories can be selected by a user with a mouse pointer. In this illustration, the keyboard 508 and the gaming controller 515 were selected for customization. Upon selecting the keyboard 508 and the gaming controller 515 from the scrollable window of section 517, the AMS application presents the keyboard 508 and the gaming controller 515 in split windows 518, 520, respectively, to assist the user during the customization process.

In step 908, the AMS application can be programmed to detect a user-selection of a particular software application such as a game. This step can be the result of the user entering in a Quick Search field 560 the name of a gaming application (e.g., World of Warcraft™ or WoW). Upon identifying a gaming application, the AMS application can retrieve in step 910 from a remote or local database gaming application actions which can be presented in a scrollable section 539 of the GUI represented as “Actions” 530. The actions can be tactical actions 532, communication actions 538, menu actions 536, and movement actions 538 which can be used to invoke and manage features of the gaming application.

The actions presented descriptively in section 530 of the GUI can represent a sequence of accessory input functions which a user can stimulate by button depressions, navigation or speech. For example, depressing the left button on the mouse 510 can represent the tactical action “Reload”, while the simultaneous keyboard depressions “Ctrl A” can represent the tactical action “Melee Attack”. For ease of use, the “Actions” 530 section of the GUI is presented descriptively rather than by a description of the input function(s) of a particular accessory.

Any one of the Actions 530 can be associated with one or more input functions of the accessories being customized in windows 518 and 520 by way of a drag and drop action or other customization options. For instance, a user can select a “Melee Attack” by placing a mouse pointer 533 over an iconic symbol associated with this action. Upon doing so, the symbol can be highlighted to indicate to the user that the icon is selectable. At this point, the user can select the icon by holding the left mouse button and drag the symbol to any of the input functions (e.g., buttons) of the keyboard 508 or selectable options of the gaming controller 515 to make an association with an input function of one of these accessories. Actions of one accessory can also be associated with another accessory that is of a different category. For example, key depressions “Ctrl A” of the key board 508 can be associated with one of the buttons of the gaming controller 515 (e.g., the left button 519).

In one embodiment, a Melee Attack action can be associated by dragging this action to either the left button 519 or right button 521 of the gaming controller 515. Thus, when the selected button is depressed, the stimulus signal that is generated by the selected button of the gaming controller 515 can be substituted by the AMS application with the Melee Attack action. In another embodiment, the Melee Action can be associated with a combination of key button presses (e.g., simultaneous depression of the left and right buttons 519, 521, or a sequence of button depressions: two rapid left button depressions followed by a right button depression).

In yet another embodiment, the Melee Action can be associated with movement of the gaming controller 515 such as, for example, rapid movement or shaking of the gaming controller 515. In a further embodiment, the AMS application can be adapted to make associations with two dimensional or three dimensional movements of the gaming controller 515 according to a gaming venue state. For example, suppose the player's avatar enters a fighter jet. In this gaming venue state, moving the left navigation knob forward can be associated by the AMS application with controlling the throttle of the jet engines. Rapidly moving the gaming controller 515 downward can represent release of munitions such as a bomb.

In a gaming venue state where the gamer's avatar has entered a building, lifting of the gaming controller 515 above a first displacement threshold can be associated with a rapid movement of the avatar up one floor. A second displacement threshold can be associated with a rapid movement of the avatar down one floor—the opposite of the first displacement threshold. Alternatively, the second displacement threshold could be associated with a different action such as jumping between buildings when the avatar is on the roof of a building.

The AMS application can associate standard stimuli generated by manipulating a gaming accessory with substitute stimuli that control gaming actions of a video game. The AMS application can be adapted to perform these associations based on a gaming venue state such as the ones described above. Accordingly, the associations made between stimuli supplied by an accessory such as the gaming controller 515 can be venue state dependent. The gaming venue state can be a description of a gaming state (e.g., entering a tank which requires the use of gaming controls for a tank), captured images of the gaming venue state (e.g., one or more still images of a tank, or a video of an avatar entering a tank), and/or application programming instructions (API) messages which can be received from the gaming application to enable the AMS application to identify the occurrence of a particular gaming venue state.

At step 912 the AMS application can also respond to a user selection of a profile. A profile can be a device profile or master profile invoked by selecting GUI button 556 or 558, each of which can identify the association of gaming actions with input functions of one or more accessories. If a profile selection is detected in step 912, the AMS application can retrieve in step 918 macro(s) and/or prior associations defined by the profile. The actions and/or macros defined in the profile can also be presented in step 916 by the AMS application in the actions column 530 of the GUI 501 to modify existing profile associations or create new associations. In one embodiment, the profile can be used for storing expected movement or other data that can be utilized for determining whether an adjustment to a generated user input stimuli should be performed.

In step 918, the AMS application can also respond to a user selection to create a macro. A macro in the present context can mean any actionable command which can be recorded by the AMS application. An actionable command can represent a sequence of stimuli generated by manipulating input functions of an accessory, a combination of actions in the Action section 530, an identification of a software application to be initiated by an operating system (OS), or any other recordable stimulus to initiate, control or manipulate software applications. For instance, a macro can represent a user entering the identity of a software application (e.g., instant messaging tool) to be initiated by an OS upon the AMS application detecting through speech recognition a speech command.

A macro can also represent recordable speech delivered by a microphone singly or in combination with a headset for detection by another software application through speech recognition or for delivery of the recorded speech to other parties. In yet another embodiment a macro can represent recordable navigation of an accessory such as a joystick of the gaming controller 515, recordable selections of buttons of the gaming controller 515, and so on. Macros can also be combinations of the above illustrations with selected actions from the Actions 530 menu. Macros can be created from the GUI 501 by selecting a “Record Macro” button 588. The macro can be given a name and category in user-defined fields 580 and 582.

Upon selecting the Record Macro button 588, a macro can be generated by selection of input functions on an accessory (e.g., Ctrl A, speech, navigation knob movements of the gaming controller 515, etc.) and/or by manual entry in field 544 (e.g., typing the name and location of a software application to be initiated by an OS, such as an instant messaging application, keyboard entries such as Ctrl A, etc.). Once the macro is created, it can be tested by selecting button 550 which can repeat the sequence specified in field 544. The clone button 552 can be selected to replicate the macro sequence if desired. Fields 552 can also present timing characteristics of the stimulation sequence in the macro with the ability to modify and thereby customize the timing of one or more stimulations in the stimulation sequence. Once the macro has been fully defined, selection of button 588 records the macro in step 920. The recording step can be combined with a step for adding the macro to the associable items Actions column 530, thereby providing the user the means to associate the macro with input functions of the accessories (e.g., one or more keys of the keyboard 108, buttons of the gaming controller 515, etc.).

In step 922, the AMS application can respond to drag and drop associations of actions and input functions of the keyboard 508 or the gaming controller 515. Associations can also be made based on the two or three dimensional movements of the gaming controller 515. If user input indicates that a user is performing an association, the AMS application can proceed to step 928 where it can determine if a profile has been identified in step 912 to record the association(s) detected. If a profile has been identified, the associations are recorded/stored in the profile in step 926. If a profile has not been identified in step 912, the AMS application can create a profile in step 928 for recording the detected associations. In the same step, the user can name the newly created profile as desired. The newly created profile can also be associated with one or more gaming software applications in step 930 for future reference. The AMS application can also record in a profile in step 926 associations based on gaming venue states. In this embodiment the same stimuli generated by the gaming controller 515 can result in different substitutions based on the gaming venue state detected by the AMS application.

The AMS application can be adapted to utilize image processing technology to detect a gaming venue state according to pre-stored images or video clips stored in the profile. For example, the AMS application can use image processing technology to identify an avatar of a gamer and track what the avatar does as directed by the gamer. For example, if the avatar enters a tank, the image processing technology of the AMS application can detect a gaming venue state associated with the use of a tank, and thereby identify associations between accessory stimuli and substitute stimuli according to the detected gaming venue state.

Referring back to step 926, once the associations have been recorded in a profile, the AMS application can determine in step 932 which of the accessories shown illustratively in FIGS. 1-2 and 4 are programmable and available for programming If the AMS application detects that the accessories (e.g., keyboard 508, gaming controller 515) are communicatively coupled to a computing device from which the AMS application is operating (e.g., gaming console 150) and programmable, the AMS application can proceed to step 938 of FIG. 9 where it submits the profile and its contents for storage in one of the accessories (e.g., the gaming controller 515) or the dongle 603. Once the gaming controller 515, dongle 603, or combinations thereof are programmed with the profile, such devices can perform stimuli substitutions according to the associations recorded by the AMS application in the profile. Alternatively, the AMS application can store the profile in the computing device 150 and perform substitutions of stimuli supplied by the gaming controller 515 according to associations recorded in the profile by the AMS application.

The GUI 501 of FIG. 5 presented by the AMS application can have other functions. For example, the GUI 501 can provide options for layout of the accessory selected (button 522), how the keyboard is illuminated when associations between input functions and actions are made (button 538), and configuration options for the accessory (button 526). The AMS application can adapt the GUI 501 to present more than one functional GUI page. For instance, by selecting button 502, the AMS application can adapt the GUI 501 to present a means to create macros and associate actions to accessory input functions as depicted in FIG. 5. Selecting button 504 can cause the AMS application to adapt the GUI 501 to present statistics from stimulation information and/or gaming action results captured by the AMS application. Selecting button 506 can also cause the AMS application to adapt the GUI 501 to present promotional offers and software updates.

The steps of method 900 in whole or in part can be repeated until a desirable pattern is achieved of associations between stimulus signals generated by accessories and substitute stimuli. It would be apparent to an artisan with ordinary skill in the art that there can be numerous other approaches to accomplish the embodiments described by method 900 or variants thereof. These undisclosed approaches are contemplated by the present disclosure.

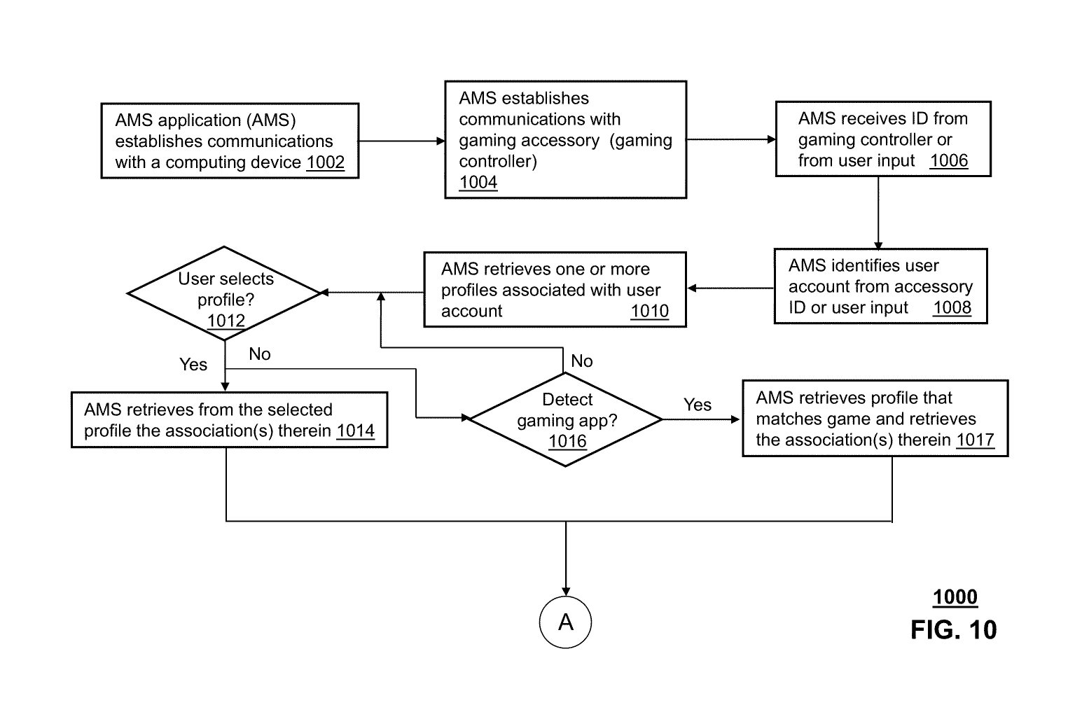

FIG. 10 depicts a method 1000 for illustrating the operations of the AMS application for either of the configurations shown in FIGS. 6-7. In one or more embodiments, the AMS application can be operating in whole or in part from the gaming controller 515, the dongle 603, the gaming console 150, a remote server (not shown), or a computing device such as a desktop computer (also not shown). For illustration purposes, it is assumed the AMS application operates from the gaming console 150. Method 1000 can begin with the AMS application establishing communications in steps 1002 and 1008 between the gaming console 150 and a gaming accessory such as the gaming controller 515, and a headset 514 such as shown in FIG. 5. These steps can represent for example a user starting the AMS application from the gaming console 150 and/or the user inserting at a USB port of the gaming console 150 a connector of a USB cable tethered to the gaming controller 515, which invokes the AMS application. In step 1006, the gaming controller 515 and/or headset 514 can in turn provide the AMS application one or more accessory ID's, or the user can provide by way of a keyboard or the gaming controller 515 user identification. With the accessory ID's, or user input the AMS application can identify in step 1008 a user account associated with the gaming controller 515 and/or headset 514. In step 1010, the AMS application can retrieve one or more profiles associated with the user account.

In step 1012, the user can be presented by way of a display coupled to the gaming console 150 profiles available to the user to choose from. If the user makes a selection, the AMS application proceeds to step 1018 where it retrieves from the selected profiles the association(s) stored therein. If a selection is not made, the AMS application can proceed to step 1016 where it can determine whether a software gaming application (e.g., video game) is operating from the gaming console 150 or whether the gaming console 150 is communicating with the software gaming application by way of a remote system communicatively coupled to the gaming console 150 (e.g., on-line gaming server(s) presenting, for example, World of Warcraft™). If a gaming software application is detected, the AMS application proceeds to step 1017 where it retrieves a profile that matches the gaming application detected and the association(s) contained in the profile. As noted earlier, association(s) can represent accessory stimulations, navigation, speech, the invocation of other software applications, macros or other forms of suitable associations that result in substitute stimulations. The accessory stimulations can be stimulations that are generated by the gaming controller 515, as well as stimulations from other accessories (e.g., headset 514), or combinations thereof.

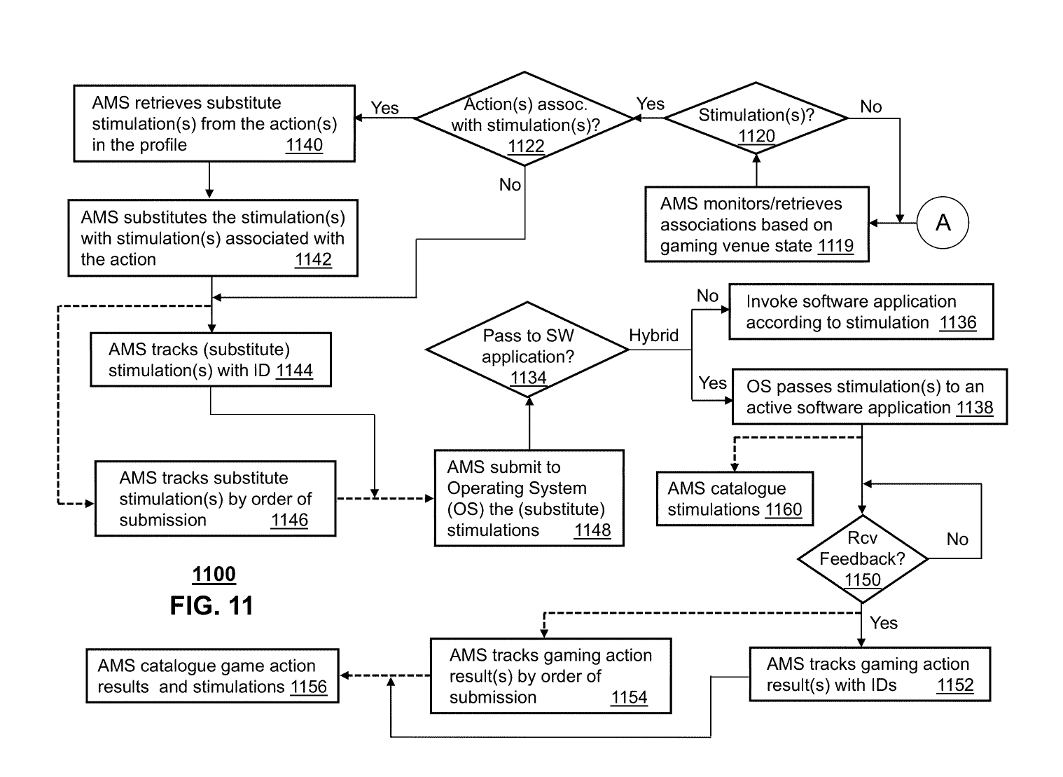

Once a profile and its contents have been retrieved in either of steps 1018 or step 1017, the AMS application can proceed to step 1119 of FIG. 11 where it monitors for a change in a gaming venue state based on the presentations made by the gaming application, or API messages supplied by the gaming application. At the start of a game, for example, the gaming venue state can be determined immediately depending on the gaming options chosen by the gamer. The AMS application can determine the gaming venue state by tracking the gaming options chosen by a gamer, receiving an API instruction from the gaming application, or by performing image processing on the video presentation generated by the gaming application. For example, the AMS application can detect that the gamer has directed an avatar to enter a tank. The AMS application can retrieve in step 1119 associations for the gaming controller 515 for controlling the tank.

The AMS application can process movements of the gaming controller 515 forwards, backwards, or sideways in two or three dimensions to control the tanks movement. Similarly, rotating the gaming controller 115 or tilting the gaming controller 515 forward can cause an accelerometer, gyro or magnetometer of the gaming controller 115 to provide navigational data to the AMS application which can be substituted with an action to cause the tank to turn and/or move forward. The profile retrieved by the AMS application can indicate that the greater the forward tilt of the gaming controller 515, the greater the speed of the tank should be moving forward. Similarly, a rear tilt can generate navigation data that is substituted with a reverse motion and/or deceleration of the forward motion to stop or slow down the tank. A three dimensional lift of the mouse can cause the tank to steer according to the three dimensional navigation data provided by the gaming controller 515. For example, navigation data associated with a combination of a forward tilt and right bank of the gaming controller 515 can be substituted by the AMS application to cause an increase in forward speed of the tank with a turn to the right determined by the AMS application according to a degree of banking of the gaming controller 515 to the right. In the above embodiment, the three dimensional navigation data allows a gamer to control any directional vector of the tank including speed, direction, acceleration and deceleration.

In another illustration, the AMS application can detect a new gaming venue state as a result of the gamer directing the avatar to leave the tank and travel on foot. Once again the AMS application retrieves in step 1119 associations related to the gaming venue state. In this embodiment, selection of buttons of the gaming controller 515 can be associated by the AMS application with weaponry selection, firing, reloading and so on. The movement of the gaming controller 515 in two or three dimensions can control the direction of the avatar and/or selection or use of weaponry. Once the gaming venue state is detected in step 1119, the AMS application retrieves the associations related to the venue state, and can perform substitutions of stimuli generated by the gaming controller 515, and/or speech commands received by microphone of the headset 514.

The AMS application can monitor in step 1120 stimulations generated by the accessories coupled to the gaming console 150. The stimulations can be generated by the gamer by manipulating the gaming controller 515, and/or by generating speech commands detected by the headset 514. If a simulation is detected at step 1120, the AMS application can determine in step 1122 whether to forward the detected stimulation(s) to an Operating System (OS) of the gaming console 150 without substitutions. This determination can be made by comparing the detected stimulation(s) to association in the profile. If the detected stimulation(s) match the associations, then the AMS application proceeds to step 1180 where it retrieves substitute stimulation(s) in the profile. In step 1182, the AMS application can substitute the detected stimulation(s) with the substitute stimulations in the profile. In one embodiment, the AMS application can track in step 1188 the substitute stimulations by updating these stimulations with a unique identifier such as a globally unique identifier (GUID). In this embodiment, the AMS application can also add a time stamp to each substitute stimulation to track when the substitution was performed.

In another embodiment, the AMS application can track each substitute stimulation according to its order of submission to the gaming application. For instance, sequence numbers can be generated for the substitute stimulations to track the order in which they were submitted to the gaming application. In this embodiment, the substitute stimulations do not need to be updated with sequence numbers or identifiers so long as the order of gaming action results submitted by the gaming application to the AMS application remain in the same order as the substitute stimulations were originally submitted.

For example, if a first stimulation sent to the gaming application by the AMS application is a command to shoot, and a second stimulation sent to the gaming application is a command to shoot again, then so long as the gaming application provides a first a game action result for the first shot, followed by a game action result for the second shot, then the substitute stimulations will not require updating with sequence numbers since the game action results are reported in the order that the stimulations were sent. If on the other hand, the game action results can be submitted out of order, then updating the stimulations with sequence numbers or another suitable identifier would be required to enable the AMS application to properly track and correlate stimulations and corresponding gaming action results.

Once the stimulations received in step 1120 have been substituted with other stimulations in step 1182, and the AMS application has chosen a proper tracking methodology for correlating gaming action results with stimulations, the AMS application can proceed to step 1188 and submit the substitute stimulations to the OS of the gaming console 150. If in step 1122 the detected stimulation(s) do not match an association in the profile, then the AMS application proceeds to one of steps 1188 or 1186 in order to track the stimulations of the accessory. Once the AMS application has performed the necessary steps to track the stimulation as originally generated by the accessory, the AMS application proceeds to step 1188 where it submits stimulations (with or without substitutions) to the OS of the gaming console 150 with or without tracking information as previously described.

In step 1138, the OS determines whether to invoke in step 1136 a software application identified in the stimulation(s) (e.g., gamer says “turn on team chat”, which invokes a chat application), whether to forward the received stimulations to the gaming software application in step 1138, or combinations thereof. Contemporaneous to the embodiments described above, the AMS application can monitor in step 1150 for game action results supplied by the gaming application via a defined API. The game action results can be messages sent by the gaming application by way of the API of the gaming application to inform the AMS application what has happened as a result of the stimulations sent in step 1138. For instance, suppose the stimulation sent to the gaming application in step 1138 is a command to shoot a pistol. The gaming application can determine that the shot fired resulted in a miss of a target. The gaming application can respond with a message which is submitted by way of the API to the AMS application that indicates the shot fired resulted in a miss. If IDs such as GUIDs were sent with each stimulation, the gaming application can submit game action results with their corresponding GUID to enable the AMS application to correlate the gaming action results with stimulations having the same GUID.

For example, if the command to shoot included the ID “1238”, then the game action result indicating a miss will include the ID “1238”, which the AMS application can use in step 1152 to identify the stimulation having the same ID. If on other hand, the order of game action results can be maintained consistent with the order of the stimulations, then the AMS application can correlate in step 1158 stimulations with game action results by the order in which stimulation were submitted and the order in which game action results were received. In step 1156, the AMS application can catalogue stimulations and game action results. In another embodiment, the AMS application can be adapted to catalogue the stimulations in step 1160. In this embodiment, step 1160 can be performed as an alternative to steps 1150 through 1156. In another embodiment, step 1160 can be performed in combination with steps 1150 through 1156 in order to generate a catalogue of stimulations, and a catalogue for gaming action results correlated to the stimulations.

The methods of FIGS. 9-11 can be adapted to operate in whole or in part in a gaming accessory, in an operating system of a computer, in a gaming console, in a gaming application that generates the video game, in a dongle, or any other suitable software application and/or device.

The method of FIG. 11 can be adapted to ignore or filter game action results, which may not be relevant to the gamer or analysts. For instance, the AMS application can be adapted to ignore (or filter) game action results relating to navigation of the avatar (e.g., turn around, jump, etc.). The AMS application can also be adapted to ignore (or filter) game action results relating to preparatory actions such as reloading a gun, switching between weapons, and so on. In another embodiment, the AMS application can be adapted to selectively monitor only particular game result actions such as misses, non-kill hits, kills, and life of the avatar. The AMS application can also be adapted to monitor gaming action results with or without temporal data associated with the stimuli and game action results.

In one embodiment, the AMS application can be adapted to track stimuli (or substitutions thereof) by submission order, and order of gaming action results supplied by the gaming application, and perform cataloguing thereof by the respective order of stimuli and gaming action results. The items can be catalogued by the AMS application with or without temporal data.

In one embodiment, the AMS application can be adapted to collect gaming action results for “all” or a substantial portion of stimuli (or substitutions thereof) transmitted to the gaming application. In this embodiment, the AMS application can be adapted to enable a gamer to replay portions of the game to allow the gamer to visualize (in slow motion, still shots, or regular play speed) the actions taken by the gamer (i.e., accessory stimuli and/or substitute stimuli) to help the gamer identify areas of the game where his/her performance can be improved.

In one embodiment, the AMS application can be implemented as a distributed system (e.g., one or more servers executing one or more virtual machines) enabling multiples users to control aspects of the AMS application. For example, in a tournament setting, gaming analysts having access to the AMS application can request a replay of portions of the game to demonstrate exceptional plays versus missed plays at a JumboTron™ display. The gamers can access the AMS application to establish new substitute stimuli, perform calibrations on macros, or invoke or create additional gaming profiles. Portions of the AMS application can also be implemented by equipment of unaffiliated parties or service providers of gaming services.

In one embodiment, the AMS application can be adapted to substitute an accessory stimulus (or stimuli) for a macro comprising a combination of substitute stimuli, and track the macro when gaming action results are received from the gaming application rather than track each individual substitute stimulus of the macro. The AMS application can be adapted to monitor macros by tracking an order of stimuli (or substitutes) associated with the macro that are transmitted to the gaming application and by tracking an order of gaming action results received from the gaming application, which are associated with the macro. Alternatively, or in combination the AMS application can add a unique identifier to the substitute stimuli to identify the stimuli as being associated with the macro.

The AMS application can be adapted to catalogue the gaming action results associated with the macro in a manner that allows the gamer to identify a group of gaming action results as being associated with the macro. The AMS application can also be adapted to collect sufficient data to assess each individual gaming action result of the macro (e.g., temporal data, hits, misses, etc.). The presentation of catalogued macro data can be hierarchical. For example, the AMS application can present a particular macro by way of a high level GUI that indicates the macro caused a kill. The AMS application can be adapted to enable the gamer to select a different GUI that enables the user to visualize a gaming action result for each stimulus of the macro to determine how effective the macro was in performing the kill, and whether further adjustments of the macro might improve the gamer's performance.

In one embodiment, a movement sensor of the system can detect the movement of the peripheral device, where the movement is utilized for generating the user input stimulus for the video game. In another embodiment, the movement associated with the peripheral device can be a virtual movement in the video game caused by detected biometric parameters associated with a user of the peripheral device. In another embodiment, the movement associated with the peripheral device can be a virtual movement in the video game caused by detected game parameters associated with an event in the video game. In another embodiment, the movement associated with the peripheral device can be movement of the peripheral device caused by detected biometric parameters associated with a user of the peripheral device. In another embodiment, the movement associated with the peripheral device can be movement of the peripheral device caused by detected game parameters associated with an event in the video game.

As an example, a biometric sensor can detect a user biometric parameter (e.g., an elevated heart rate). The user biometric parameter can cause movement associated with the peripheral device, such as a shaking of the peripheral device and/or a virtual shaking in the video game (e.g., a gun-sight in a shooter game moving about the screen instead of remaining steady). The exemplary embodiments can make adjustments to these movements, such as corrections, movement reductions, and so forth. In other examples, the movement associated with the peripheral device can be caused by events in the game, such as a pressure situation in a football game in which the peripheral device is caused to shake or receiver routes are shown in an obfuscated pattern. The exemplary embodiments can make adjustments to these movements, such as corrections, movement reductions, and so forth. The determination of whether the stimulus is “invalid” can be based on various factors including thresholds, prior user recorded movements, game objectives, user skill levels, and so forth. These factors can be set by the user, by the video game, and/or by another entity.

The foregoing embodiments are a subset of possible embodiments contemplated by the present disclosure. Other suitable modifications can be applied to the present disclosure.

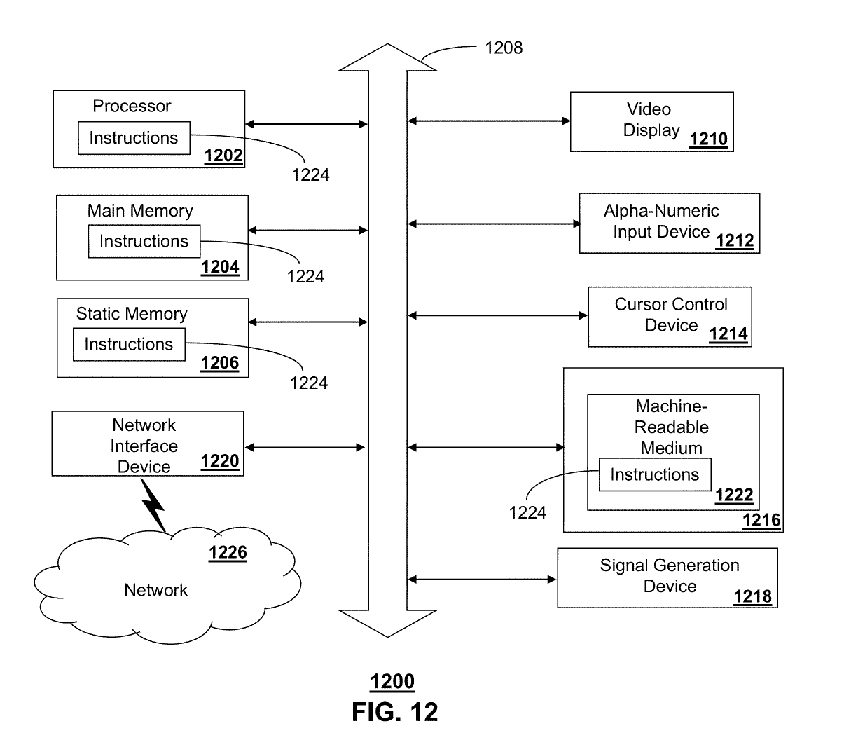

FIG. 12 depicts an exemplary diagrammatic representation of a machine in the form of a computer system 1200 within which a set of instructions, when executed, may cause the machine to perform any one or more of the methods discussed above. One or more instances of the machine can operate as any of devices depicted in or otherwise utilized by FIGS. 1-11, including the peripheral device 120, the peripheral filtering module 825 and so forth. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 1200 may include a processor 1202 (e.g., a central processing unit (CPU), a graphics processing unit (GPU, or both), a main memory 1208 and a static memory 1206, which communicate with each other via a bus 1208. The computer system 1200 may further include a video display unit 1210 (e.g., a liquid crystal display (LCD), a flat panel, or a solid state display. The computer system 1200 may include an input device 1212 (e.g., a keyboard), a cursor control device 1218 (e.g., a mouse), a disk drive unit 1216, a signal generation device 1218 (e.g., a speaker or remote control) and a network interface device 1220.

The disk drive unit 1216 may include a tangible computer-readable storage medium 1222 on which is stored one or more sets of instructions (e.g., software 1228) embodying any one or more of the methods or functions described herein, including those methods illustrated above. The instructions 1228 may also reside, completely or at least partially, within the main memory 1208, the static memory 1206, and/or within the processor 1202 during execution thereof by the computer system 1200. The main memory 1208 and the processor 1202 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 1222 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the present disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) are contemplated for use by computer system 1200.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, are contemplated by the present disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
determining a movement associated with a peripheral device;
determining, by a processor of a system, whether a user input stimulus is an invalid stimulus for a video game based on the determining of the movement; and
causing, by the processor, a stimuli signal to be adjusted to generate an adjusted stimuli signal responsive to a determination that the user input stimulus is the invalid stimulus for the video game, wherein the stimuli signal is generated by the peripheral device and includes the user input stimulus.

2. The method of claim 1, comprising detecting, by a movement sensor of the system, the movement of the peripheral device, wherein the movement is utilized for generating the user input stimulus for the video game.

3. The method of claim 1, wherein the movement associated with the peripheral device is a virtual movement in the video game caused by detected biometric parameters associated with a user of the peripheral device.

4. The method of claim 1, wherein the movement associated with the peripheral device is a virtual movement in the video game caused by detected game parameters associated with an event in the video game.

5. The method of claim 1, wherein the movement associated with the peripheral device is movement of the peripheral device caused by detected biometric parameters associated with a user of the peripheral device.

6. The method of claim 1, wherein the movement associated with the peripheral device is movement of the peripheral device caused by detected game parameters associated with an event in the video game.

7. The method of claim 1, comprising transmitting the adjusted stimuli signal to a computing device presenting the video game for implementing user control of the video game, wherein the adjusting of the stimuli signal comprises deleting the user input stimulus from the adjusted stimuli signal and maintaining one or more non-adjusted user input stimuli in the adjusted stimuli signal that are determined to be valid stimuli for the video game.

8. The method of claim 1, wherein the determining whether the user input stimulus is the invalid stimulus for the video game comprises comparing the movement of the peripheral device with an expected movement of the peripheral device to identify whether the movement of the peripheral device satisfies a movement threshold.

9. The method of claim 8, wherein the movement threshold is determined based on at least one of a type of the video game or a type of the peripheral device.

10. The method of claim 8, wherein the expected movement is determined based on a monitored history of user input stimuli associated with a user playing the video game.

11. The method of claim 1, wherein the adjusted stimuli signal includes a non-adjusted user input stimulus that is determined to be a valid stimulus for the video game.

12. The method of claim 1, wherein the adjusting of the stimuli signal comprises altering movement data associated with the user input stimulus without deleting the user input stimulus from the adjusted stimuli signal.

13. The method of claim 1, wherein the system is removably connectable with the peripheral device.

14. The method of claim 1, wherein a computing device presenting the video game presents a user control recommendation responsive to a transmitting of the adjusted stimuli signal, and wherein the user control recommendation includes information associated with avoiding the movement of the peripheral device.

15. The method of claim 1, wherein the system is integrated with the peripheral device and wherein a movement sensor of the system includes at least one of an accelerometer, a gyroscope or a magnetometer.

16. An apparatus, comprising:
a memory to store computer instructions;
a movement sensor; and
a processor coupled with the memory and the movement sensor, wherein the processor, responsive to executing the computer instructions, performs operations comprising:
detecting a movement of a peripheral device utilizing the movement sensor, wherein a user input stimulus is generated for a video game according to the movement; and
causing a stimuli signal to be adjusted to generate an adjusted stimuli signal responsive to a determination that the user input stimulus is an invalid stimulus for a video game, wherein the stimuli signal includes the user input stimulus, wherein the adjusted stimuli signal is provided to a computing device presenting the video game.

17. The apparatus of claim 16, wherein the movement sensor includes at least one of an accelerometer, a gyroscope or a magnetometer.

18. The apparatus of claim 16, wherein the adjusting of the stimuli signal comprises deleting the user input stimulus from the adjusted stimuli signal and maintaining one or more non-adjusted user input stimuli in the adjusted stimuli signal that are determined to be valid stimuli for the video game.

19. The apparatus of claim 16, wherein the adjusting of the stimuli signal comprises altering movement data associated with the user input stimulus without deleting the user input stimulus from the adjusted stimuli signal.

20. The apparatus of claim 16, wherein the determination that the user input stimulus is the invalid stimulus for the video game comprises comparing the movement of the peripheral device with an expected movement of the peripheral device to identify whether the movement of the peripheral device satisfies a movement threshold.

21. The apparatus of claim 20, wherein the expected movement is determined based on a monitored history of user input stimuli associated with a user playing the video game.

22. The apparatus of claim 16, wherein a computing device presenting the video game presents a user control recommendation responsive to the providing of the adjusted stimuli signal, and wherein the user control recommendation includes information associated with avoiding the movement of the peripheral device.

23. A non-transitory computer-readable storage medium comprising computer instructions which, responsive to being executed by a processor, cause the processor to perform operations comprising:
determining whether a user input stimulus is an invalid stimulus for a video game, wherein the user input stimulus is generated based on a movement of a peripheral device; and
causing an adjustment or deletion of the user input stimulus responsive to a determination that the user input stimulus is the invalid stimulus for the video game.

24. The non-transitory computer-readable storage medium of claim 23, wherein the operations further comprise:
generating an adjusted stimuli signal based on the adjustment or deletion of the user input stimulus; and
transmitting the adjusted stimuli signal to a computing device presenting the video game for implementing user control of the video game.

25. The non-transitory computer-readable storage medium of claim 23, wherein the operations further comprise:
monitoring user input stimuli for a user of the video game to generate a stimuli history for the user, wherein the determining of whether the user input stimulus is the invalid stimulus for the video game is based on the stimuli history.
